(19) United States
(12) Patent Application Publication
(10) Pub. No.: US 2008/0062160 A1
(43) Pub. Date: Mar. 13, 2008

(54) Video display driving method of LCD apparatus

(75) Inventor: Feng-Li Lin, Taishan Township (TW)

Correspondence Address: BIRCH STEWART KOLASCH & BIRCH, PO BOX 747, FALLS CHURCH, VA, 22040-0747, US

(73) Assignee: Gigno Technology Co., Ltd.

(21) Appl. No.: 11/892,480

(22) Filed: Aug. 23, 2007

(30) Foreign Application Priority Data
Sep. 12, 2006 (TW) 095133748

(51) Int. Cl. G09G 5/00

(52) U.S. Cl. 345/205

(57) ABSTRACT

A video display driving method includes: a data transforming process of transforming first sub-video frame data into a preset-voltage signal and a post-set-voltage signal and transforming second sub-video frame data into a preset-voltage signal and a post-set-voltage signal; a display driving process of sequentially writing the preset-voltage signal and the post-set-voltage signal of the first sub-video frame data and the preset-voltage signal and the post-set-voltage signal of the second sub-video frame data into a pixel during a frame time; a light control process of controlling a brightness of light of a first light-emitting unit to present a first average brightness during a corresponding time of writing the preset-voltage signal of the first sub-video frame data into the pixel, and to present a second average brightness higher than the first average brightness during a corresponding time of writing the post-set-voltage signal of the first sub-video frame data into the pixel.

### CROSS REFERENCE TO RELATED APPLICATIONS

This Non-provisional application claims priority under 35 U.S.C. §119(a) on Patent Application No(s). 095133748 filed in Taiwan, Republic of China on Sep. 12, 2006, the entire contents of which are hereby incorporated by reference.

### BACKGROUND OF THE INVENTION

1. Field of Invention

The invention relates to a video display driving method of a display apparatus, and, in particular, to a video display driving method of a liquid crystal display (LCD) apparatus capable of eliminating a blurring phenomenon.

2. Related Art

LCDs may be classified into a LCD for a typical display screen and a LCD for a television. In fact, the basic structures of the two kinds of LCDs are similar to each other except for some components, some circuits and the positions of some components.

Referring to FIG. 1, a conventional LCD mainly includes a LCD panel 1, a backlight module 2, a driving circuit 3 and a control circuit 4. The LCD panel 1 at least includes a liquid crystal layer 11, a color filter substrate 12, a transistor circuit substrate 13 and two polarizers 14 and 15. The liquid crystal layer 11 is disposed between the color filter substrate 12 and the transistor circuit substrate 13, and the polarizers 14 and 15 are respectively disposed on sides of the color filter substrate 12 and the transistor circuit substrate 13. The backlight module 2 mainly includes a lightbox 21 and a driver 22 for driving a light source. The lightbox 21 includes a plurality of light emitting elements 211 and a diffuser plate 212. In general, the light emitting element 211 may be a cold cathode fluorescent lamp (CCFL). The driving circuit 3 is electrically connected to and drives the LCD panel 1. Typically, the driving circuit 3 is composed of a plurality of driving ICs and at least one driving circuit board. The control circuit 4 controls the driving circuit 3 and thus the LCD panel 1. The control circuit 4 and the driver 22 are often disposed on the same side of the lightbox 21. The lightbox 21 is disposed adjacent to the LCD panel 1 so that the light source of the light emitting element 211 of the lightbox 21 may illuminate the LCD panel 1 and the light emitted from the light emitting element 211 is presented on a display surface 16 of the LCD panel 1.

As for the video display driving method of the LCD apparatus, the blurring phenomenon may occur when motion pictures are displayed on the display surface 16 of the LCD panel 1 because the response time of the liquid crystal in the liquid crystal layer 11 is longer. To solve this problem, the manufacturers have recently paid attention to the development of the liquid crystal having the faster response time. However, the liquid crystal having the faster response time increases the difficulty in the processes of manufacturing the LCD panel 1. In addition, even if the response time of the liquid crystal becomes faster, the blurring phenomenon may also occur when the motion pictures are displayed on the display surface 16 of the LCD panel 1. The reason is that the display mode of the conventional LCD apparatus pertains to a holding type display mode. In this mode, the blurring phenomenon still occurs when the motion pictures are displayed on the display surface 16 of the LCD panel 1 even if the response time of the liquid crystal is sufficiently fast. This is because the human eyes involuntarily track the moving object in the frame when watching the motion pictures, and the eye persistence of vision also exists.

The influence of the response time of the liquid crystal on the video will be described with reference to FIGS. 2A to 2D. In FIG. 2A, a voltage signal V₁ is sequentially written into a pixel of the display surface 16 throughout two frame times. As shown in FIG. 2B, when the response time of the liquid crystal is longer, the liquid crystal corresponding to the pixel cannot immediately reach the steady state, so the transmittance (the curve depicted by the solid line in FIG. 2B) of the pixel during the first frame time T₁ cannot reach the transmittance Tr₁ corresponding to the voltage signal V₁, and even the transmittance of the pixel during the second frame time T₂ cannot completely reach the transmittance Tr₁ corresponding to the voltage signal V₁. In the case of using the liquid crystal with the longer response time, the transmittance (the curve depicted by the dashed line in FIG. 2B) of the pixel during the first frame time T₁ still cannot reach the transmittance Tr₁ corresponding to the voltage signal V₁, but the transmittance of the pixel can almost reach the transmittance Tr₁ corresponding to the voltage signal V₁ during the second frame time T₂. Correspondingly, as shown in FIG. 2C, if the light source of the light emitting element 211 with the illumination intensity L₁ is used, the brightness presented by the pixels on the display surface 16 is shown in FIG. 2D. Using the liquid crystal with the shorter response time can enable the pixel to reach the desired brightness more rapidly. However, if the display mode of the conventional LCD displays video continuously, and the number of control variables for performing the dynamic brightness control is increased then no matter how short the response time of the liquid crystal is, the conventional LCD still provides poor quality video in the video frame and thus poor quality to the user.

In addition to the usage of the liquid crystal having the faster response time, some manufacturers have recently disclosed the over-driving technology, as shown in FIG. 3A, in which an over-driving voltage signal V₂ corresponding to a voltage signal V₁ and the voltage signal V₁ are sequentially written with respect to a position of any pixel on the display surface 16 during the first frame time T₁ and the second frame time T₂. As shown in FIG. 3B, the over-driving voltage signal V₂ is applied during the first frame time T₁, so the transmittance of the pixel may almost reach the desired liquid crystal transmittance Tr₁ corresponding to the voltage signal V₁ during the first frame time T₁. At this time, as shown in FIG. 3C, if the light emitting element 211 provides the light with the illumination intensity L₁, the brightness presented at the position of the pixel on the display surface 16 is shown in FIG. 3D. The over-driving technology can provide a predetermined improved effect to the response speed of the liquid crystal. However, the problem of the blurring phenomenon cannot be completely eliminated by simply using the over-driving technology because the display mode of the conventional LCD apparatus pertains to the holding type display mode.

With the development of the backlight module driving technology, the light source is not requested to emit light uniformly and continuously any more, but is further requested to emit light in a blinking manner so as to reach the effect of the impulse-type display mode in order to solve the blurring phenomenon of the motion pictures caused by the holding type display mode. Thus, the technology combining the over-driving technology and the blanking lighting has been induced. As shown in FIG. 4A, an over-driving voltage signal V₂ corresponding to a voltage signal V₁ and the voltage signal V₁ are sequentially written with respect to a position of any pixel on the display surface 16 during the first frame time T₁ and the second frame time T₂. As shown in FIG. 4B, the over-driving voltage signal V₂ is applied during the first frame time T₁. Thus, the transmittance of the pixel can almost reach the desired transmittance Tr₁ corresponding to the voltage signal V₁ during the first frame time T₁. At this time, as shown in FIG. 4C, if the light emitting element 211 provides the light with the illumination intensity L₁ and the duty cycle of 50% in a blanking manner, the brightness presented at the position of the pixel on the display surface 16 is shown in FIG. 4D. As shown in FIG. 4D, the display mode has been changed to the impulse-type display mode. So, the effect of eliminating the blurring phenomenon using this method is better than that using the above-mentioned method. Nevertheless, the total brightness presented by the pixel during the first frame time T₁ and the second frame time T₂ are still different from each other. So, this method still has drawbacks.

As described hereinabove, the blurring phenomenon cannot be completely improved either using the liquid crystal with the quick response or the over-driving technology in conjunction with the technology of driving the backlight module in a blanking manner. Therefore, it is an important subject to provide a video display driving method of a LCD apparatus to completely improve the blurring phenomenon.

### SUMMARY OF THE INVENTION

In view of the foregoing, the invention is to provide a video display driving method of a LCD apparatus capable of completely improving a blurring phenomenon.

To achieve the above, the invention discloses a video display driving method of a liquid crystal display (LCD) apparatus. The LCD apparatus includes a LCD panel and a backlight module. The LCD panel has a plurality of pixels distributed over a display surface of the LCD panel. The LCD panel receives a plurality of sets of video frame data, which includes first sub-video frame data and second sub-video frame data. The backlight module has a first light-emitting unit and a second light-emitting unit, which have different color systems. The light generated by the first light-emitting unit and the light generated by the second light-emitting unit are respectively projected onto the display surface of the LCD panel. The video display driving method includes a data transforming process, a display driving process and a light control process. The data transforming process is to transform the first sub-video frame data of the video frame data into a preset-voltage signal and a post-set-voltage signal of the first sub-video frame data for respectively driving the pixels, and to transform the second sub-video frame data of the video frame data into a preset-voltage signal and a post-set-voltage signal of the second sub-video frame data for driving the pixels. The display driving process is to sequentially write the preset-voltage signal of the first sub-video frame data, the post-set-voltage signal of the first sub-video frame data, the preset-voltage signal of the second sub-video frame data and the post-set-voltage signal of the second sub-video frame data into the pixels of the LCD panel during a frame time. The light control process is to control a brightness of the light of the first light-emitting unit for presenting a first average brightness during a corresponding time of writing the preset-voltage signal of the first sub-video frame data into the pixel, and for presenting a second average brightness higher than the first average brightness during a corresponding time of writing the post-set-voltage signal of the first sub-video frame data into the pixel.

As mentioned above, the video display driving method of the LCD apparatus according to the invention is to sequentially write the preset-voltage signal and the post-set-voltage signal of each of the sub-video frame data of the video frame data into a pixel during a frame time. In addition, the method further controls the brightness of the first light-emitting unit to present the first average brightness and the second average brightness, which is higher than the first average brightness, during each time of writing the preset-voltage signal and the post-set-voltage signal. Compared with the prior art, the invention achieves the over-driving technology by the preset-voltage signal of each of the video frame data, and achieves the technology of driving the light of the backlight module in the blanking manner by controlling the brightness of the light of each of the light-emitting units of the backlight module. In this manner, the blurring phenomenon of the human vision can be improved. Furthermore, the power for the backlight module can be reduced to achieve the power-saving effect because the brightness of each of the light-emitting units is decreased or each of the light-emitting units is turned off.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration showing a cross-sectional side view of a conventional LCD;

FIG. 2A is a schematic illustration showing a driving voltage variation of a pixel in a video display driving method of the conventional LCD;

FIG. 2B is a schematic illustration showing a transmittance variation of the pixel of FIG. 2A, wherein a solid line represents a transmittance of a liquid crystal of the pixel having the longer response time, and a dashed line represents a transmittance of a liquid crystal of the pixel having the faster response time;

FIG. 2C is a schematic illustration showing a light intensity variation of the backlight module corresponding to the position of the pixel;

FIG. 2D is a schematic illustration showing a brightness variation presented by the pixel on the display surface;

FIG. 3A is a schematic illustration showing a driving voltage variation of a pixel in another conventional video display driving method of the LCD apparatus;

FIG. 3B is a schematic illustration showing a transmittance variation of the pixel of FIG. 3A;

FIG. 3C is a schematic illustration showing a light intensity variation of the backlight module corresponding to the position of the pixel;

FIG. 3D is a schematic illustration showing a brightness variation presented by the pixel on the display surface;

FIG. 4A is a schematic illustration showing a driving voltage variation of a pixel in still another conventional video display driving method of the LCD apparatus;

FIG. 4B is a schematic illustration showing a transmittance variation of the pixel of FIG. 4A;

FIG. 4C is a schematic illustration showing a light intensity variation of the backlight module corresponding to the position of the pixel;

FIG. 4D is a schematic illustration showing a brightness variation presented by the pixel on the display surface;

FIG. 5 is an exploded view showing a LCD apparatus according to a preferred embodiment of the invention;

FIG. 6 is a schematic illustration showing video frame data and a frame time corresponding thereto in the LCD apparatus according to the preferred embodiment of the invention;

FIG. 7 is a flow chart showing a video display driving method of the LCD apparatus according to the preferred embodiment of the invention;

FIG. 8A is a schematic illustration showing a driving voltage variation of the sub-video frame data of the pixel in the video display driving method according to the preferred embodiment of the invention;

FIG. 8B is a schematic illustration showing a transmittance variation of the pixel of FIG. 7A; and

FIG. 8C is a schematic illustration showing an average intensity variation of the light of the backlight module corresponding to the position of the pixel according to the preferred embodiment of the invention.

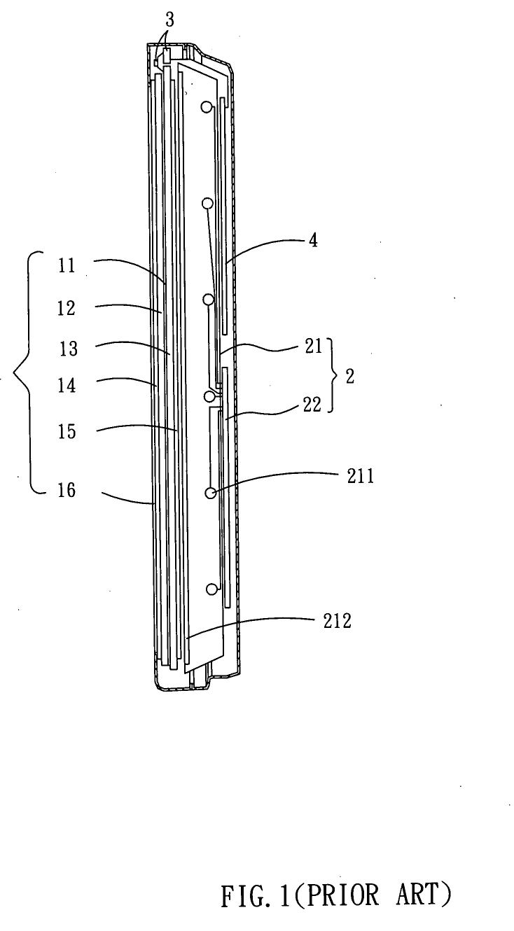

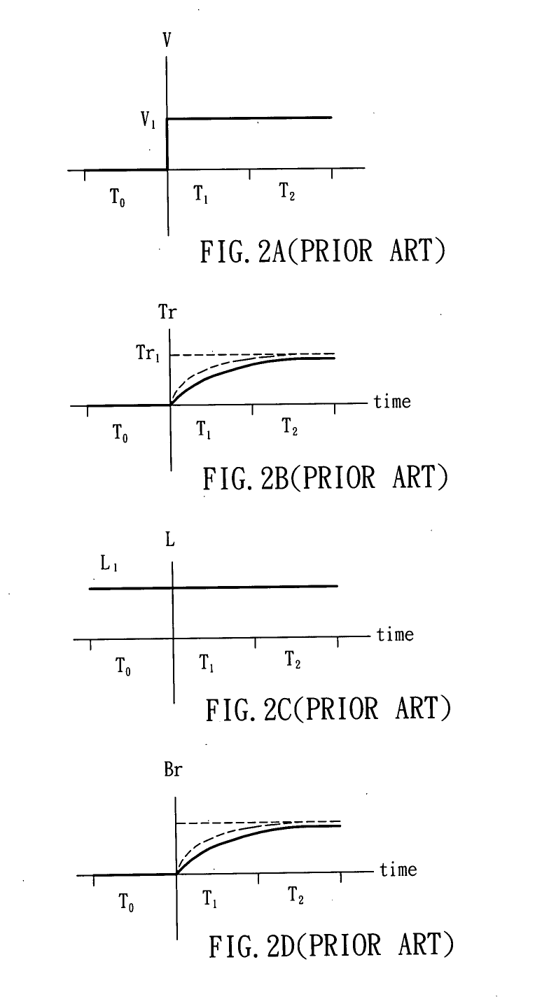

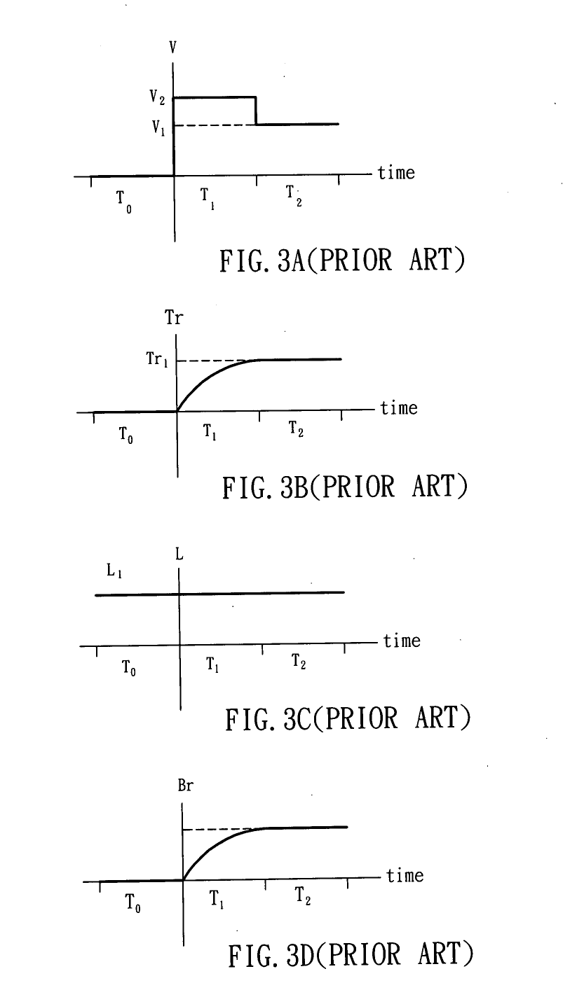

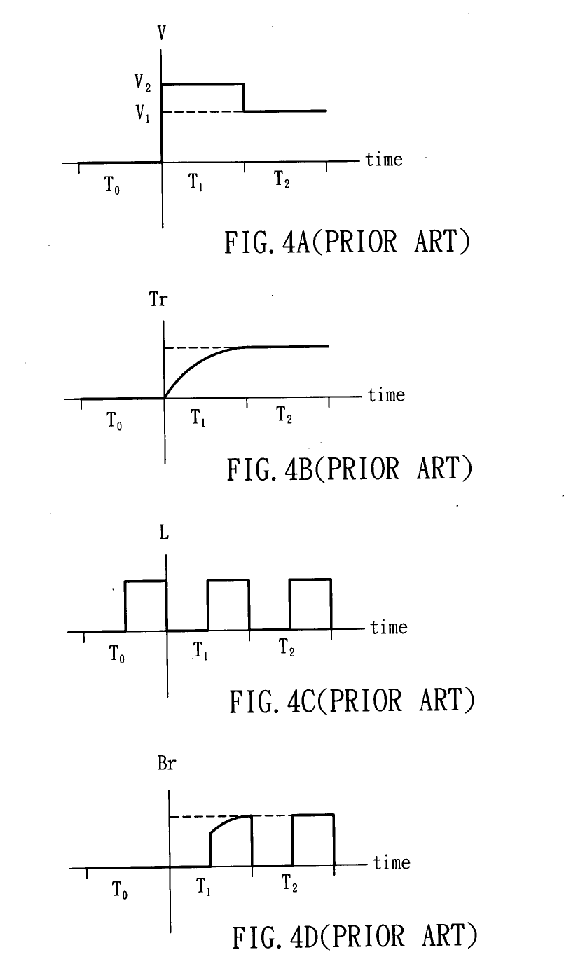

### DETAILED DESCRIPTION OF THE INVENTION

The present invention will be apparent from the following detailed description, which proceeds with reference to the accompanying drawings, wherein the same references relate to the same elements.

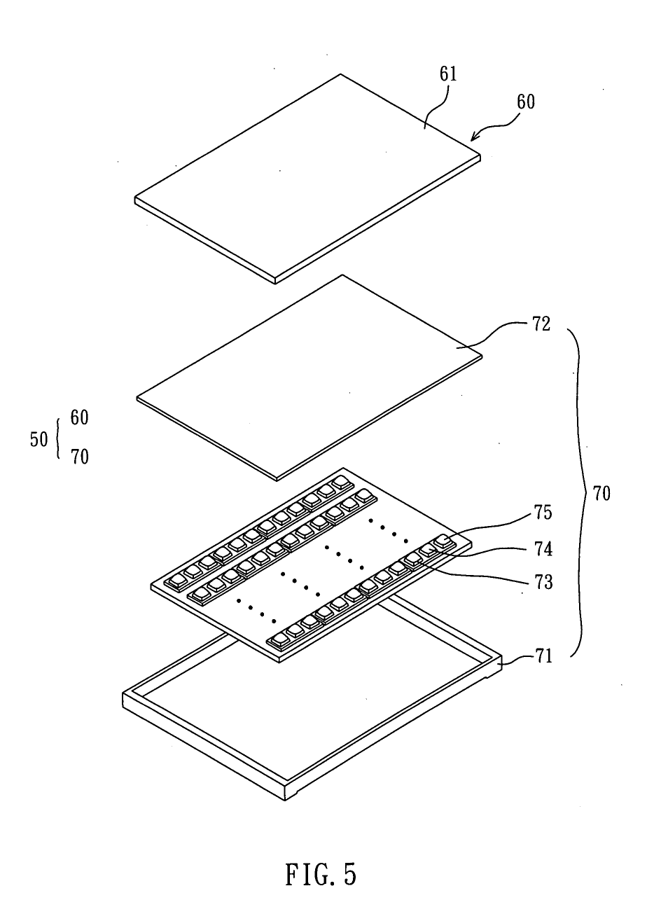

As shown in FIG. 5, a video display driving method of a liquid crystal display (LCD) apparatus according to this embodiment is applied to a LCD apparatus 50, which includes a LCD panel 60 and a backlight module 70 disposed on one side of the LCD panel 60. In addition, the LCD apparatus 50 of this embodiment is not particularly restricted and may be implemented as a LCD television or a typical display.

The LCD panel 60 has a display surface 61 and a plurality of pixels (not shown) distributed over the display surface. The LCD panel 60 receives a plurality of sets of video frame data, each of which has first sub-video frame data, second sub-video frame data and third sub-video frame data.

In addition, the backlight module 70 of this embodiment is not particularly restricted and may be a direct type backlight module or a side-edge backlight module. Herein, the backlight module 70 is the direct type backlight module. The backlight module 70 has a casing 71, a diffuser plate 72 and a first light-emitting unit 73, a second light-emitting unit 74 and a third light-emitting unit 75. The light-emitting units 73, 74 and 75 have different color systems, are disposed between the diffuser plate 72 and the casing 71, and output light respectively projected onto the display surface 61 of the LCD panel 60 via the diffuser plate 72. The first light-emitting unit 73, the second light-emitting unit 74 and the third light-emitting unit 75 of this embodiment may be implemented as LEDs for respectively outputting the light with different color systems, so each of the light-emitting units 73 to 75 may be respectively implemented as a red LED, a blue LED or a green LED. In this example, the backlight module 70 has a plurality of first light-emitting units 73, a plurality of second light-emitting units 74 and a plurality of third light-emitting units 75, and the first light-emitting unit 73 is the red LED, the second light-emitting unit 74 is the blue LED, and the third light-emitting unit 75 is the green LED.

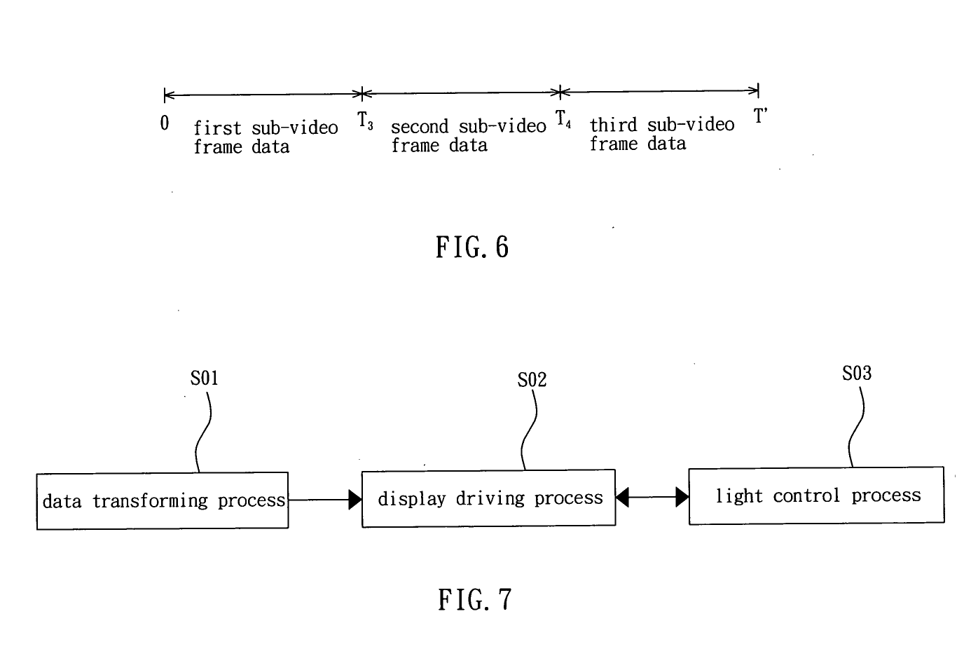

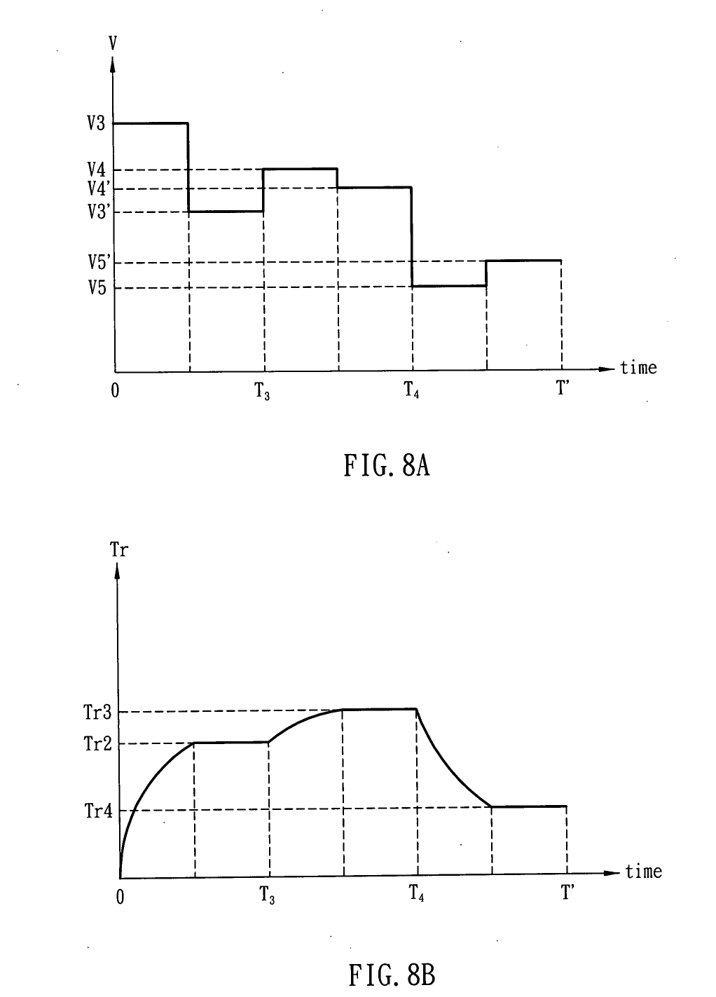

As shown in FIG. 6, one of the pixels of the LCD panel 60 and the video frame data corresponding to the pixel will be illustrated during a frame time T′ as an example. The first sub-video frame data is displayed during the time from 0 to T₃, the second sub-video frame data is displayed during the time from T₃ to T₄, and the third sub-video frame data is displayed during the time from T₄ to T′. As shown in FIG. 7, the video display driving method includes the following processes S01 to S03.

The process S01 is a data transforming process of transforming the first sub-video frame data into a preset-voltage signal V3 and a post-set-voltage signal V3′ of the first sub-video frame data for driving the pixel, transforming the second sub-video frame data into a preset-voltage signal V4 and a post-set-voltage signal V4′ of the second sub-video frame data for driving the pixel, and transforming the third sub-video frame data of the video frame data into a preset-voltage signal V5 and a post-set-voltage signal V5′ of the third sub-video frame data for driving the pixel. In addition, the preset-voltage signals V3, V4 and V5 of the sub-video frame data (i.e., the first sub-video frame data, the second sub-video frame data and the third sub-video frame data) are a set of over-driving voltage signals corresponding to the post-set-voltage signals V3′, V4′ and V5′ thereof (i.e., the first sub-video frame data, the second sub-video frame data and the third sub-video frame data) in this embodiment.

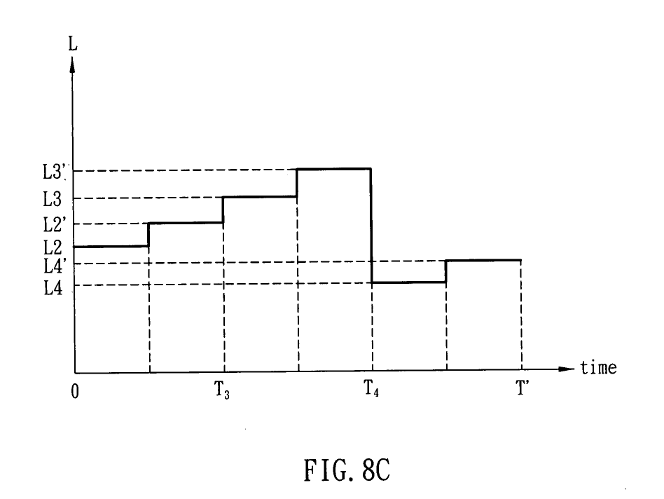

As shown in FIG. 8A, the process S02 is a display driving process of sequentially writing the preset-voltage signal V3 of the first sub-video frame data, the post-set-voltage signal V3′ of the first sub-video frame data, the preset-voltage signal V4 of the second sub-video frame data, the post-set-voltage signal V4′ of the second sub-video frame data, the preset-voltage signal V5 of the third sub-video frame data and the post-set-voltage signal V5′ of the third sub-video frame data into the pixel of the LCD panel 60 during the frame time T′. In other words, the preset-voltage signal V3 of the first sub-video frame data is first written during the frame time T′, and the preset-voltage signal V3 of the first sub-video frame data drives the pixel during the time from 0 to T₃/2. Next, the post-set-voltage signal V3′ of the first sub-video frame data is written, and the post-set-voltage signal V3′ of the first sub-video frame data drives the pixel during the time from T₃/2 to T₄. Then, the preset-voltage signal V4 of the second sub-video frame data is written, and the preset-voltage signal V4 of the second sub-video frame data drives this pixel during the time from T₃ to (T₄-T₃)/2. Next, the post-set-voltage signal V4′ of the second sub-video frame data is written, and the post-set-voltage signal V4′ of the second sub-video frame data drives the pixel during the time from (T₄-T₃)/2 to T₄. Thereafter, the preset-voltage signal V5 of the third sub-video frame data is written, and the preset-voltage signal V5 of the third sub-video frame data drives the pixel during the time from T₄ to (T′-T₄)/2. Then, the post-set-voltage signal V5′ of the third sub-video frame data is written, and the post-set-voltage signal V5′ of the third sub-video frame data drives the pixel during the time from (T′-T₄)/2 to T′.

As shown in FIG. 8B, the corresponding over-driving voltage signals (i.e., the preset-voltage signals V3, V4 and V5) are utilized to drive the pixel during the times from 0 to T₃/2, from T₃ to (T₄-T₃)/2 and from T₄ to (T′-T₄)/2, respectively, so that the transmittance Tr of the pixel may almost reach the desired liquid crystal transmittance Tr2 corresponding to the preset-voltage signal V3 within the time T₃/2, reach the desired liquid crystal transmittance Tr3 corresponding to the preset-voltage signal V4 within the time (T₄-T₃)/2, and reach the desired liquid crystal transmittance Tr4 corresponding to the preset-voltage signal V5 within the time (T′-T₄)/2.

Of course, the preset-voltage signal of the first sub-video frame data, the post-set-voltage signal of the first sub-video frame data, the preset-voltage signal of the second sub-video frame data, the post-set-voltage signal of the second sub-video frame data, the preset-voltage signal of the third sub-video frame data and the post-set-voltage signal of the third sub-video frame data, which correspond to a next video frame, are also sequentially written into the pixel corresponding to the next video frame during the next frame time (not shown).

In addition, the human eyes have the persistence of vision, so the frame time T′ of this embodiment is set to the time between 1/50 seconds and 1/120 seconds.

As shown in FIG. 8C, the process S03 is a light control process of controlling the brightness of the light the first light-emitting unit 73 to present a first average brightness L2 during a corresponding time of writing the preset-voltage signal V3 of the first sub-video frame data into the pixel and to present a second average brightness L2′ during the corresponding time of writing the post-set-voltage signal V3′ of the first sub-video frame data into the pixel. The light control process also controls the brightness of the light of the second light-emitting unit 74 to present a third average brightness L3 during the corresponding time of writing the preset-voltage signal V4 of the second sub-video frame data into the pixel and to present a fourth average brightness L3′ during the corresponding time of writing the post-set-voltage signal V4′ of the second sub-video frame data into the pixel. The light control process further controls the brightness of the light of the third light-emitting unit 75 to present a fifth average brightness L4 during the corresponding time of writing the preset-voltage signal V5 of the third sub-video frame data into the pixel and to present a sixth average brightness L4′ during the corresponding time of writing the post-set-voltage signal V5′ of the third sub-video frame data into the pixel.

In this embodiment, the second average brightness L2′ is higher than the first average brightness L2, the fourth average brightness L3′ is higher than the third average brightness L3, the sixth average brightness L4′ is higher than the fifth average brightness L4, the first average brightness L2 is lower than 20% of the second average brightness L2′, the third average brightness L3 is lower than 20% of the fourth average brightness L3′, and the fifth average brightness L4 is lower than 20% of the sixth average brightness L4′. Of course, the first light-emitting unit 73, the second light-emitting unit 74 and the third light-emitting unit 75 are respectively turned on when the transmittance of the liquid crystal has reached the correct transmittance in a preferred condition. In other words, the first average brightness L2, the third average brightness L3 and the fifth average brightness L4 are equal to 0 in the preferred condition.

In this embodiment, the brightness of the light of each of the first light-emitting unit 73, the second light-emitting unit 74 and the third light-emitting unit 75 is controlled to reach each average brightness. The method of controlling the brightness of the light is not particularly restricted. In practice, it is possible to decrease the brightness of the first light-emitting unit during the corresponding time of writing the preset-voltage signal V3 of the first sub-video frame data into the pixel, and to increase the brightness of the first light-emitting unit 73 during the corresponding time of writing the post-set-voltage signal V3′ of the first sub-video frame data into the pixel; to decrease the brightness of the second light-emitting unit during the corresponding time of writing the preset-voltage signal V4 of the second sub-video frame data, and to increase the brightness of the second light-emitting unit during the corresponding time of writing the post-set-voltage signal V4′ of the second sub-video frame data into the pixel; and to decrease the brightness of the third light-emitting unit during the corresponding time of writing the preset-voltage signal V5 of the third sub-video frame data into the pixel and to increase the brightness of the third light-emitting unit during the corresponding time of writing the post-set-voltage signal V5′ of the third sub-video frame data into the pixel.

In another method (not shown) of controlling the brightness of the light, it is possible to turn off the first light-emitting unit 73 during the corresponding time of writing the preset-voltage signal V3 of the first sub-video frame data into the pixel and to turn on the first light-emitting unit 73 during the corresponding time of writing the post-set-voltage signal V3′ of the first sub-video frame data into the pixel; to turn off the second light-emitting unit 74 during the corresponding time of writing the preset-voltage signal V4 of the second sub-video frame data into the pixel and to turn on the second light-emitting unit 74 during the corresponding time of writing the post-set-voltage signal V4′ of the second sub-video frame data into the pixel; and to turn off the third light-emitting unit 75 during the corresponding time of writing the preset-voltage signal V5 of the third sub-video frame data into the pixel and to turn on the third light-emitting unit 75 during the corresponding time of writing the post-set-voltage signal V5′ of the third sub-video frame data into the pixel. In this manner, the blurring phenomenon of the human vision can be improved. Furthermore, the power for the backlight module 70 can be reduced to achieve the power-saving effect because the brightness of each of the first light-emitting unit 73, the second light-emitting unit 74 and the third light-emitting unit 75 is decreased or each of the first light-emitting unit 73, the second light-emitting unit 74 and the third light-emitting unit 75 is turned off.

In summary, the video display driving method of the LCD apparatus according to the invention is to sequentially write the preset-voltage signal and the post-set-voltage signal of each of the sub-video frame data of the video frame data into a pixel during a frame time. In addition, the method further controls the brightness of the first light-emitting unit to present the first average brightness and the second average brightness, which is higher than the first average brightness, during each time of writing the preset-voltage signal and the post-set-voltage signal. Compared with the prior art, the invention achieves the over-driving technology by the preset-voltage signal of each of the video frame data, and achieves the technology of driving the light of the backlight module in the blanking manner by controlling the brightness of the light of each of the light-emitting units of the backlight module. In this manner, the blurring phenomenon of the human vision can be improved. Furthermore, the power for the backlight module can be reduced to achieve the power-saving effect because the brightness of each of the light-emitting units is decreased or each of the light-emitting units is turned off.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A video display driving method of a liquid crystal display (LCD) apparatus, wherein the LCD apparatus comprises a LCD panel and a backlight module, the LCD panel has a plurality of pixels distributed over a display surface of the LCD panel, the LCD panel receives a plurality of sets of video frame data, which comprises first sub-video frame data and second sub-video frame data, the backlight module has a first light-emitting unit and a second light-emitting unit, which have different color systems, and light generated by the first light-emitting unit and light generated by the second light-emitting unit are respectively projected onto the display surface of the LCD panel, the video display driving method comprising:
a data transforming process of transforming the first sub-video frame data of the video frame data into a preset-voltage signal and a post-set-voltage signal of the first sub-video frame data for respectively driving the pixels, and transforming the second sub-video frame data of the video frame data into a preset-voltage signal and a post-set-voltage signal of the second sub-video frame data for driving the pixels;
a display driving process of sequentially writing the preset-voltage signal of the first sub-video frame data, the post-set-voltage signal of the first sub-video frame data, the preset-voltage signal of the second sub-video frame data and the post-set-voltage signal of the second sub-video frame data into the pixels of the LCD panel during a frame time; and
a light control process of controlling a brightness of the light of the first light-emitting unit to present a first average brightness during a corresponding time of writing the preset-voltage signal of the first sub-video frame data into the pixel, and to present a second average brightness higher than the first average brightness during a corresponding time of writing the post-set-voltage signal of the first sub-video frame data into the pixel.

2. The method according to claim 1, wherein the first average brightness is lower than 20% of the second average brightness.

3. The method according to claim 1, wherein the light control process further comprises:
controlling a brightness of the light of the second light-emitting unit to present a third average brightness during a corresponding time of writing the preset-voltage signal of the second sub-video frame data into the pixel, and to present a fourth average brightness higher than the third average brightness during a corresponding time of writing the post-set-voltage signal of the second sub-video frame data into the pixel.

4. The method according to claim 3, wherein the third average brightness is lower than 20% of the fourth average brightness.

5. The method according to claim 1, wherein
the brightness of the light of the first light-emitting unit is decreased during the corresponding time of writing the preset-voltage signal of the first sub-video frame data into the pixel, and the brightness of the light of the first light-emitting unit is increased during the corresponding time of writing the post-set-voltage signal of the first sub-video frame data into the pixel; or
the brightness of the light of the second light-emitting unit is decreased during the corresponding time of writing the preset-voltage signal of the second sub-video frame data into the pixel, and the brightness of the light of the second light-emitting unit is increased during the corresponding time of writing the post-set-voltage signal of the second sub-video frame data into the pixel.

6. The method according to claim 1, wherein
the first light-emitting unit is turned off during the corresponding time of writing the preset-voltage signal of the first sub-video frame data into the pixel, and the first light-emitting unit is turned on during the corresponding time of writing the post-set-voltage signal of the first sub-video frame data into the pixel; or
the second light-emitting unit is turned off during the corresponding time of writing the preset-voltage signal of the second sub-video frame data into the pixel, and the second light-emitting unit is turned on during the corresponding time of writing the post-set-voltage signal of the second sub-video frame data into the pixel.

7. The method according to claim 1, wherein each of the first light-emitting unit and the second light-emitting unit of the backlight module is a light-emitting diode (LED).

8. The method according to claim 7, wherein the first light-emitting unit or the second light-emitting unit is a red light emitting diode (LED), a blue LED or a green LED.

9. The method according to claim 1, wherein in the data transforming process, the preset-voltage signal of the first sub-video frame data is a set of over-driving voltage signals corresponding to the post-set-voltage signal of the first sub-video frame data, or the preset-voltage signal of the second sub-video frame data is a set of over-driving voltage signals corresponding to the post-set-voltage signal of the second sub-video frame data.

10. The method according to claim 1, wherein the sets of video frame data further have third sub-video frame data, the backlight module further has a third light-emitting unit having a color system different that of each of the first light-emitting unit and the second light-emitting unit, and light generated by the third light-emitting unit is projected onto the display surface of the LCD panel.

11. The method according to claim 10, wherein the light control process further comprises:
controlling a brightness of the light of the third light-emitting unit to present a fifth average brightness during a corresponding time of writing the preset-voltage signal of the third sub-video frame data into the pixel, and to present a sixth average brightness higher than the fifth average brightness during a corresponding time of writing the post-set-voltage signal of the third sub-video frame data into the pixel.

12. The method according to claim 11, wherein the fifth average brightness is lower than 20% of the sixth average brightness.

13. The method according to claim 11, wherein the brightness of the light of the third light-emitting unit is decreased during the corresponding time of writing the preset-voltage signal of the third sub-video frame data into the pixel, and the brightness of the light of the third light-emitting unit is increased during the corresponding time of writing the post-set-voltage signal of the third sub-video frame data into the pixel.

14. The method according to claim 11, wherein the third light-emitting unit is turned off during the corresponding time of writing the preset-voltage signal of the third sub-video frame data into the pixel, and the third light-emitting unit is turned on during the corresponding time of writing the post-set-voltage signal of the third sub-video frame data into the pixel.

15. The method according to claim 10, wherein the third light-emitting unit of the backlight module is a light-emitting diode (LED).

16. The method according to claim 15, wherein the third light-emitting unit is a red LED, a blue LED or a green LED.

17. The method according to claim 10, wherein in the data transforming process, the preset-voltage signal of the third sub-video frame data is a set of over-driving voltage signals corresponding to the post-set-voltage signal of the third sub-video frame data.

18. The method according to claim 1, wherein the frame time is shorter than or equal to 1/50 seconds and is longer than or equal to 1/120 seconds.

19. The method according to claim 1, wherein the backlight module is a direct type backlight module or a side-edge backlight module.

20. The method according to claim 1, wherein the LCD apparatus is a LCD TV.
